(19) United States
(12) Patent Application Publication
(10) Pub. No.: US 2007/0187491 A1
(43) Pub. Date: Aug. 16, 2007

(54) Processing Cashless Transactions of Remote Field Assets

(76) Inventors: Bryan W. Godwin, Round Rock, TX (US); James M. Canter, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/673,089

(22) Filed: Feb. 9, 2007

Related U.S. Application Data
(60) Provisional application No. 60/772,744, filed on Feb. 13, 2006.

(51) Int. Cl. G06K 5/00; G06Q 40/00

(52) U.S. Cl. 235/380; 705/35

(57) ABSTRACT

A field asset for use in a machine to machine environment that includes a plurality of field assets in communication with a remote transaction processing server may comprise a card reader and an extended function adapter (EFA). The card reader may detect a cashless payment card presented to the card reader and the EFA may facilitate a cashless transaction in response to presentment of the cashless payment card to the card reader. The EFA may be operable to locally authorize the cashless transaction based on locally stored transaction information if said field asset lacks connectivity to the remote transaction processing server and may further be operable to remotely authorize the cashless transaction based on remotely stored transaction information if the field asset has connectivity to the remote transaction processing server.

### TECHNICAL FIELD

The present invention relates in general to the field of transaction processing and, more particularly, processing of remotely occurring cashless purchasing transactions.

### BACKGROUND OF THE INVENTION

Cashless purchasing transactions or, more simply, cashless transactions are increasing in popularity in areas where cash transactions dominated until very recently. The advent of pay at the pump gas stations, for example, produced an increase in the number of gas purchasing transactions using conventional or general purpose credit cards. Similarly, the relatively recent acceptance of credit cards in grocery stores and fast food restaurants has increased the number of such transactions made in a cashless form.

Despite the increased use of credit cards and other cashless mechanisms, there are still some areas of conventional retail in which cash transactions tend to dominate. One such area is sales of products though vending machines. Traditionally, multiple factors have contributed to the limited the use of cashless mechanisms in vending machines transactions.

The price point of items sold in vending machines has traditionally been below a level at which the transaction costs associated with cashless transactions would justify the use of cashless payment. The transaction costs associated with general purpose credit cards including VISA, MASTERCARD, DISCOVER, AMERICAN EXPRESS, and the like, are generally calculated by adding a fixed cost, sometimes referred to as a swipe charge, to a variable cost based on the sales price. Thus, for example, a credit card transaction might cost the retailer or vendor a charge determined according to a formula such as TC=FC+RATE*SP, where TC is transaction cost, FC is the fixed cost or swipe charge, RATE is a percentage, and SP is the sales price received for an item.

For items with relatively high price points, the transaction costs are approximately equal to the RATE. For items below a certain price point, however, the transaction costs begin to rise as a percentage of the sales price. Assuming, for example, a RATE of 2%, FC exceeds RATE*SP for all items with a price point under 5 USD and, therefore, the effective transaction cost rate is at least twice the value of RATE.

Another factor limiting the frequency of cashless transactions in the vending machine setting is associated with delay time or latency. Cashless transactions generally require some form of validation and/or authorization to prevent fraud or theft. Conventional validation and authorization require time as the vending machine must communicate, usually via a relatively slow connection, with a remote database, for example, a database maintained by the credit card issuer. The connection may be a wireless or wire line connection. Vending machine customers, on the other hand, generally expect no or very little latency in conjunction with a purchase.

Cashless transaction latency may itself be a product of another characteristic of vending machine purchases. Vending machines are frequently located in places that have poor locations for reception and transmission of wireless signals. Vending machines in office buildings, public buildings, apartment complexes, hotels, and the like, are frequently located in stair wells or other places that do not receive strong wireless signals. In these locations, verification of cashless transactions using traditional wireless connections may be slow, intermittent, and unreliable thereby resulting in slow transaction or transactions that do not complete successfully.

### SUMMARY OF THE INVENTION

Therefore a need exists for a method and system to facilitate cashless transactions that are fast, reliable, inexpensive, and are not entirely dependent on remote connectivity.

In accordance with teachings of the present disclosure, a system and method are provided that facilitate cashless transactions in vending machines and other field assets by employing techniques for reducing perceived latency, offering cashless transactions when wireless access is intermittent, incorporating features such as local authorization and validation, and bundling transactions for payment processing as a single transaction to reduce transaction costs.

In accordance with one embodiment of the present disclosure, a method of processing transactions is provided. A field asset may detect the initiation of a cashless transaction. In response, the field asset may determine a cashless transaction processing (CTP) mode of the field asset. The field asset may determine authorization for the cashless transaction based at least in part on the CTP mode and a remote connectivity status (RCS) of the field asset.

In accordance with another embodiment of the present disclosure, a field asset for use in a machine-to-machine environment having a plurality of field assets in communication with a remote transaction processing server, may include a card reader and an extended function adapter (EFA). The card reader may be operable to detect a cashless payment card presented to the card reader. The EFA may be in communication with the card reader and may be operable to facilitate a cashless transaction in response to said card reader detecting presentment of the cashless payment card to the card reader by: (i) locally authorizing the cashless transaction based on locally stored transaction information if said field asset lacks connectivity to a remote transaction processing server; and (ii) remotely authorizing the cashless transaction based on remotely stored transaction information if the field asset has connectivity to the remote transaction processing server.

In accordance with yet another embodiment of the present disclosure, a computer program for facilitating cashless transactions in a field asset if provided. The computer program may be stored on a computer readable medium and executable by a processor. The computer program may comprise instructions for locally authorizing a cashless transaction based on information stored on the field asset. The computer program may further comprise instructions for remotely authorizing a cashless transaction based on information accessed via a remotely located transaction processing server.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a block diagram of selected elements of a machine-to-machine network including a plurality of remotely located field assets;

FIG. 2 is a block diagram of selected elements of a field asset of FIG. 1 implemented as a vending machine;

FIG. 3 is a block diagram of selected hardware elements of an extended function adapter of the vending machine of FIG. 2;

FIG. 4 is a block diagram of selected software or firmware modules of the vending machine of FIG. 2;

FIG. 5, which includes FIG. 5A through FIG. 5E, is a flow diagram of a method of processing cashless transactions;

FIG. 6 is a flow diagram of a validation procedure suitable for use in the flow diagram of FIG. 5; and

FIG. 7 is a state diagram illustrating an implementation of a authorization lists suitable for use in the flow diagram of FIG. 5;

FIG. 8 is a table illustrating combinations of network connectivity states and authorization states for use in a vending machine of FIG. 3.

### DETAILED DESCRIPTION OF THE INVENTION

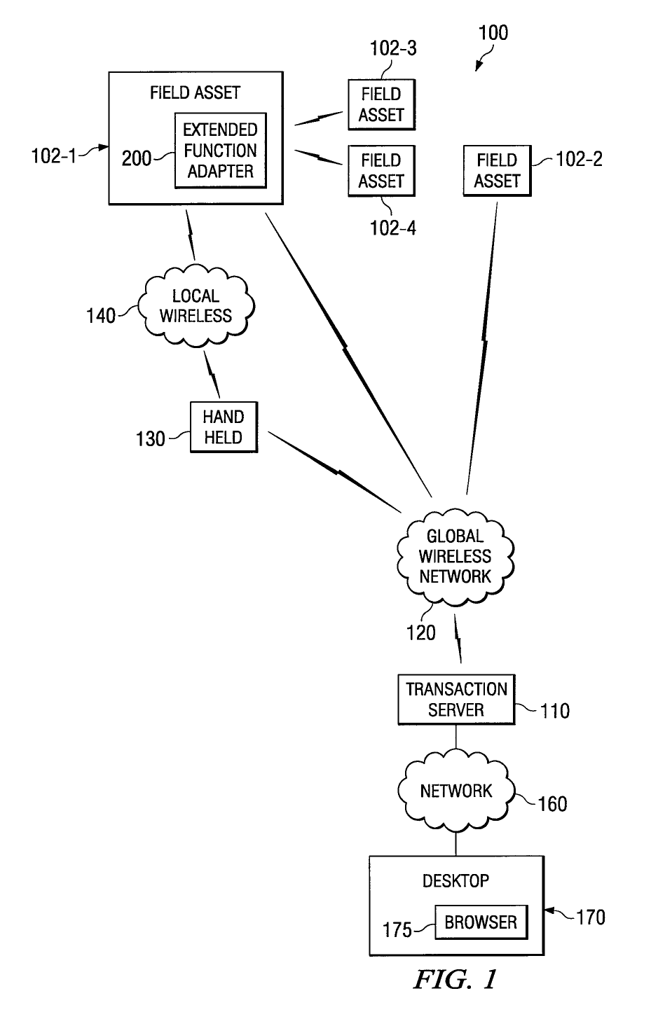

Preferred embodiments of the invention and its advantages are best understood by reference to FIG. 1 through FIG. 8, wherein like numerals indicate like and corresponding parts of the invention and wherein hyphenated reference numerals refer to specific instances of an element and the corresponding un-hyphenated reference numerals refer to an element generically or collectively.

In one aspect, a network or system including one or more remotely located field assets is described. The field assets exchange information with a transaction processing server (TPS). This type of network is sometimes referred to as machine-to-machine (M2M) network.

Connectivity between any field asset and the TPS may include wire line connectivity, local wireless connectivity, WAN or global wireless connectivity, or a combination thereof. The exchange of information between a field asset and the TPS may include the exchange of information through an intermediate device. For example, information may be exchanged between a second field asset and a first field asset and then between the first field asset and the TPS. As another example, information may be exchanged between the first field asset and the TPS through an intermediate hand held device. Connectivity between the first field asset and the hand held device may employed wire line connectivity or local wireless connectivity. The connectivity between the hand held device and the TPS may include wire line connectivity, local wireless connectivity, and/or global wireless connectivity.

The field assets described in the accompanying drawings are exemplified by vending machines in which transactions likely include the sale of consumer goods stocked in the vending machine. The vending machine preferably includes a controller that serves as the master of an industry standard bus to which one or more peripheral devices are connected. In addition to conventional vending machine peripheral devices such as bill acceptors/validators, coin changers/mechanisms, and card readers, the field asset may include hardware, firmware, and/or software that implements a platform for providing value added functionality to the vending machine or other field asset. This collection of hardware, software, and/or firmware is referred to herein as an extended function adapter (EFA).

An EFA as described herein provides features that facilitate cashless transactions. The EFA may include, as examples, features for reducing consumer-perceived latency and high-availability features. High availability features may include local authorization features to increase the availability of cashless transaction support even in environments where remote connectivity, e.g., connectivity between a remote field asset and a transaction server, is unpredictable or unreliable.

The EFA described herein may support multiple “modes” of field asset operation where a field asset's mode determines, at least in part, how a field asset's cashless transaction module operates. In some embodiments, the field asset mode is determined at least in part by the presence or absence of remote connectivity. An “online only” mode, for example, may refer to a mode in which the field asset suspends cashless transactions when remote connectivity is absent.

In addition, some embodiments of the extended function application support “multivending” and/or transaction aggregation. Multivending refers to multiple transactions associated with a single cashless authorization. Transaction aggregation refers to submitting multiple vending events as a single transaction to reduce cashless transaction costs associated with fees paid to credit card issuers.

Referring now to the drawings, FIG. 1 is a block diagram of selected elements of one embodiment of a machine-to-machine (M2M) network 100 including a set or collection of remotely located field assets 102-1 through 102-4 operable to communicate with transaction processing server (TPS) 110. Field assets 102 may be operable to engage in some form of transaction such as a sales transaction, a banking transaction, a measurement or data collection transaction, and so forth.

Although each field asset 102 is intended to encompass any suitable form of transaction performing machine or device, some embodiments of M2M network 100 include a set or collection of field assets 102 having identical or similar functionality. Examples of devices suitable for use as field assets 102 include vending machines, oil rigs, cellular phone system base stations, ATM machines, and weather monitors.

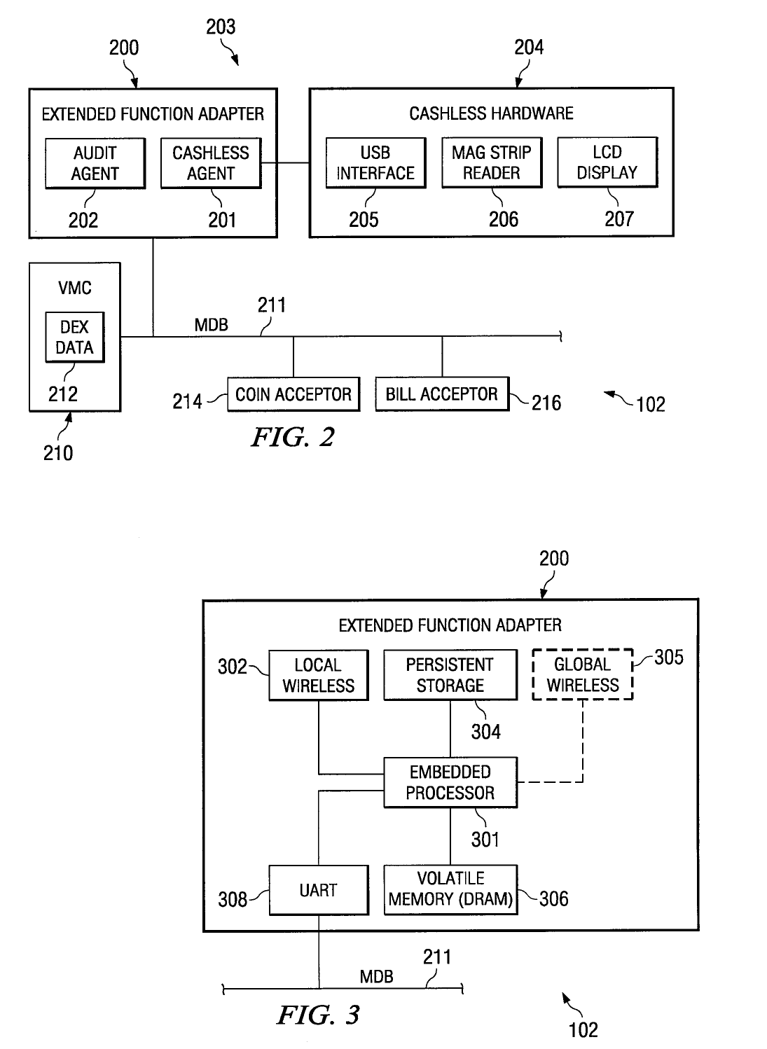

The cashless transaction processing described herein may be suitable for a vending machine class of field assets 102 and, more specifically, a vending machine class of field assets, at least one of which includes a cashless transaction module such as the cashless transaction module 150 depicted in field asset 102-1 of FIG. 1. Conventional vending machines are ubiquitous and well known devices typically used as un-manned devices for selling perishable and consumable products including canned and bottled drink products, snack foods, and so forth. Vending machines including vending machines represented by field assets 102 of FIG. 1 may, however, sell or otherwise dispense non-consumable products including, as examples, postage stamps, batteries, office supplies, toys, and countless other products. Details of one embodiment of a field asset will be described below with respect to FIG. 2.

Before describing cashless transaction elements of M2M network 100, aspects of selected communication and/or connectivity elements of M2M network 100 are described. As depicted in FIG. 1, field assets 102 are shown communicating with TPS 110 over various connectivity paths. The connectivity between TPS 110 and field asset 102-2, for example, may include wireless connectivity via global wireless network 120. Global wireless network 120 may be a wide area network that may employ cellular technology including the well known use of multiple base stations positioned in specified locations to communicate wireless signals across a wide geographic area. Thus, global wireless network 120 may include technology similar to that of commercially implemented wireless networks including commercially available CDMA and GSM digital mobile phone networks.

Field asset 102-1 is depicted as having the capability to achieve remote connectivity in at least two different ways. Like field asset 102-2, field asset 102-1 may be enabled for direct wireless connectivity with TPS 110 via global wireless network 120. Field asset 102-1 as shown may also be enabled to achieve remote connectivity with TPS 110 via an intermediary device referred to as hand held device 130 or, simply, hand held 130.

In the depicted embodiment, field asset 102-1 may achieve local connectivity with hand held 130 via a local wireless network 140. Local wireless network 140 is exemplified by a IEEE 802.11b or 802.11g(WiFi) compliant wireless network or a Bluetooth compliant network, but other network protocols may also be used. Hand held 130 may connect to TPS 110 via global wireless network 120.

A human operator or agent may typically convey hand held device 130 to a location in close proximity to a field asset 102. The field asset 102 and hand held 130 may then establish local wireless connectivity enabling communication between them. Establishing local wireless connectivity may proceed automatically without human interaction. Alternatively, input from the human operator or agent may be required to establish local wireless connectivity. The input may include, for example, a password and/or other form of authentication. The local wireless connectivity may employ or support encryption of information exchanged via the local wireless connection.

In embodiments not depicted, portions of the remote connectivity between one or more field assets 102 and TPS 110 may include wired portions. For example, field asset 102-1 may connect to hand held 130 via a wired connection such as by inserting hand held 130 or a wire or other interconnect extending from hand held 130 into a port or jack of field asset 102. Similarly, hand held 130 may also connect to TPS 110 via a wired connection.

Field assets 102-3 and 102-4 are shown as implementing their remote connectivity using field asset 102-1 as an intermediary. In some embodiments, for example, field assets 102-3 and 102-4 may include for facilities for local wireless connectivity but lack facilities for global wireless connectivity. In these embodiments, field assets 102-3 and 102-4 may communicate with TPS 110 via field asset 102-1. These embodiments of M2M network 100 beneficially reduce costs by implementing global wireless connectivity only where needed. In vending machine implementations, for example, several field assets 102 may be located within close proximity to each other within a building or site. Costs may be reduced by implementing global wireless connectivity hardware on one or a selected number of field assets within the building or site while the remaining assets or sites are able to communicate externally through these globally outfitted machines.

Regardless of the connectivity details, field assets 102 and TPS 110 exchange information. Field assets 102 may, as an example, transmit sales and inventory information, sometimes collectively referred to as audit information, to TPS 110 while TPS 110 may transmit transaction support information to field asset 102-1. Transaction support information may include, as an example, information that facilitates validation and authorization of a cashless transaction as will be discussed in greater detail below.

TPS 110 may be implemented as one or more server class computers operable to process many transactions. TPS 110 may include or may have access to a transaction database 112. Transaction database 112 may include portions that are maintained by third party providers such as commercial credit card issuers, debit card issuer including banks, and so forth. TPS 110 may also include software for processing high volumes of transactions. TPS 110 may include, as an example, a database management application (e.g., Oracle, DB2, etc.) A desktop data processing system 170 is depicted in FIG. 1 as being coupled to TPS 110 via a network 160, which may represent a conventional Ethernet or other form of LAN (Local Area Network) or intranet, an IP-based wide area network (WAN) such as the Internet, or a combination thereof. Desktop 170 may include a processor, memory, and/or I/O peripherals well known in the industry. Desktop 170 may include an operating system (OS) and a conventional web browsing application represented by reference numeral 175.

As depicted in FIG. 1, M2M network 100 may include a number of elements that facilitate high volume transaction processing in a remotely distributed environment that includes connectivity elements that may be characterized as relatively unreliable or unstable. Among these facilitating elements are (1) remote communication facilities to communicate with remote assets over multiple connectivity paths, (2) hand held technology suitable for mobile access to the field assets and to a transaction server, (3) server software for processing volumes of transactions, (4) browser-based access to useful information provided by TPS 110, and, although not depicted explicitly in FIG. 1, (5) value added facilities such as the extended functionality adapter (EFA) 200 for providing an expandable, PC industry standard communication interface to legacy equipment.

The type of information conveyed or otherwise exchanged between field assets 102 and TPS 110 may vary depending upon the application. For applications in which remote assets engage in transactions involving the sale of goods, the exchanged information may include “audit” information as well as information that enables, supports, or otherwise facilitates cashless transactions.

Audit information may include information indicative of the inventory of a field asset and information regarding cash and other funds associated with a field asset. In vending machine embodiments of field assets 102, for example, audit information may include DEX (Data Exchange) data. DEX is a well known protocol, maintained by the National Automatic Merchandising Association (NAMA), for electronic retrieval of asset-level transactions. A field asset's DEX data may be retrieved from time to time using a polling technique as is well known in the vending machine industry. DEX data may include sales mix, cash collection, product movement, and malfunction alerts.

In addition to DEX data, which may be limited to a static snapshot of the inventory and cash position of a field asset, information exchanged between field asset 102 and TPS 110 may additional transaction information. This information may include, for example, information about when a transaction occurs and other transaction details, for example, what product or combination of products were purchased, what consumer or customer purchased the product (if known), the dollar amount of the purchase, the amount of time required to complete the purchase, the manner of payment, and other information that may be useful to field asset operators and/or the providers of goods sold through field assets 102.

Referring now to FIG. 2, selected elements of an exemplary field asset 102 suitable for use in the M2M network 100 of FIG. 1 are depicted. As depicted in FIG. 2, field asset 102 may include a vending machine controller (VMC) 210 and a set of peripheral devices connected to a multi drop bus (MDB) 211. The set of peripheral devices may include EFA 200, coin acceptor 214, bill acceptor 216, and a card reader 203 that includes cashless hardware 204 and an interfacing component (not depicted explicitly in FIG. 2) of EFA 200.

EFA 200 may include support for interfacing with legacy protocols such as Data Exchange (DEX) and Multi-Drop Bus (MDB) commonly encountered in remote field asset applications and especially in the vending machine industry.

VMC 210 may function as the communication controller for interfacing peripherals 203, 214, and 216 in a vending machine implementation of field asset 102, all of which may be compliant with MDB standards. MDB compliance may ensure that the required functionality of peripheral devices including peripherals 203, 214, and 216, is compatible with the capabilities of VMC 210. MDB 211 may be a serial bus configured for master-slave operation with VMC 210 being the one, sole master capable of communicating to as many as 32 peripheral slaves. In addition, VMC 210 may maintain the field asset's DEX data 212 as depicted in FIG. 2.

VMCs such as VMC 210 and MDBs such as MDB 211 are both well known in machine-to-machine applications including vending machine applications. MDB is a standardized protocol governing the interface between VMC 210 and vending machine peripherals such as a coin acceptor/changer, bill acceptor/validator, and a card reader.

The MDB standard is jointly maintained by the National Automatic Merchandising Association (NAMA) and the EVA (the European Vending Association). MDB 211 is a bidirectional serial bus for electronically controlled vending machines that standardizes such machines so that all MDB compliant peripherals communicate in the same language and format.

The MDB standard enables instantaneous vending machine status updates in which data changes with each vend. As such, MDB may be described as a transaction-based protocol whereas DEX may be described as a cumulative reporting system. Because DEX is a cumulative-based reporting system that merely provides a snapshot of a field asset at the point in time when the DEX data is polled, DEX may not be suitable for cashless transactions.

MDB permits the attachment of a DEX-compliant audit device that acts as a passive MDB slave to receive information relevant to events that occur in the machine. In the embodiment depicted in FIG. 2, an audit agent 202 of EFA 200 may provide this audit function. In addition, audit agent 202 may be operable to communicate with VMC 210 to retrieve DEX data 212. By automatically retrieving and processing DEX data 212 from time to time, audit agent 202 may generate a dynamic view of DEX data.

Card reader 203 may be useful or necessary with respect to at least some types of cashless transactions. Card reader 203 as depicted in FIG. 2 may represent a combination of cashless agent 201 of EFA 200 and cashless hardware 204. Cashless agent 201 may implement card reader 203 by providing an interface between cashless hardware 204 and a multi-drop bus (MDB) 211 thereby enabling card reader 203 to communicate with VMC 210 in the same manner as coin acceptor/changer 214 and bill acceptor/validator 216. Cashless hardware 204 may include a USB interface 205, a magnetic strip reader 206, and an LCD display 207. LCD 207 may be viewable to a person engaging in a field asset transaction.

Field asset 102 as depicted in FIG. 2 includes elements that participate in the process of gathering, storing, transmitting, and analyzing transaction information and, more specifically for purposes of this disclosure, cashless transaction information. As its name implies, cashless transactions refer broadly to any transaction in which a non-cash form of payment is used.

Cashless transactions may include transactions using a conventional credit card, debit card, prepaid smart card, cell phone, and personal digital assistant (PDA) or other form of hand held or mobile computer. Although credit card transactions are far from being the only form of cashless transactions, the disclosure will focus on embodiments and examples in which the form of payment is assumed to be a commercially distributed credit card, e.g., a credit card on a standardized form factor having a 16 digit account number and various standardized features including as examples, the account number engraved on the front, an indication of the name of the person to whom the card was issued or whom to the card holder has authorized for purchases, an expiration date, and a coded magnetic strip on the rear of the credit card that may include some or all of this information.

Cashless transactions are of interest to vending machine operators for many reasons. Anecdotal evidence suggests, for example, a correlation between the total amount of goods purchased per transaction and the type of payment used to pay for the transaction. It is theorized that vending machine consumers who use cashless payment are more likely to spend an above average sum of money than consumers who purchase goods with cash.

In addition, cashless transactions generally provide more information regarding the identity of the consumer than conventional cash transactions, which provide no information about the consumer. Thus, cashless payment offers vending machine operators previously unattainable customer identification information. Customer identification information is useful for many reasons including, as just a couple of examples, implementing loyalty rewards programs and obtaining demographic information about consumer preferences. Thus, the field asset industry including the vending machine industry is justifiably excited about the growth prospects potentially available through cashless transactions.

As indicated previously, field asset 102 may be implemented as vending machine that includes an EFA (Extended Functionality Adapter) 200 coupled to a VMC 210 via a multi-drop bus MDB 211. Field asset 102 as depicted in FIG. 2 may also include a coin acceptor/changer 214 and a bill acceptor/validator 216 connected to MDB 211, both of which are also well known in the vending machine industry.

Referring to FIG. 3, selected hardware elements exemplary of some embodiments of EFA 200 are depicted. EFA 200 may include an embedded processor 301 and various support chips including a local wireless unit 302 to provide local wireless connectivity, a flash memory chip 304, a global wireless adapter 305 to provide global wireless connectivity, a memory (RAM) chip 306, and a UART 308 for interfacing EFA 200 to MDB 211.

Embedded processor 301 may be implemented with any of various commercially distributed embedded chips such as the PXA270 embedded device from Intel Corporation implementing the WinCE 4.2 operating system platform from Microsoft. EFA 200 may include RS232 and general purpose I/O (GPIO) ports to facilitate interfaces with field asset 102. In embodiments based on an Intel/Windows platform, the native USB (Universal Serial Bus) support may be used to implement a variety of functions including Bluetooth local wireless, WiFi local wireless, wireless wide area network, radio frequency identification (RFID), and machine access control.

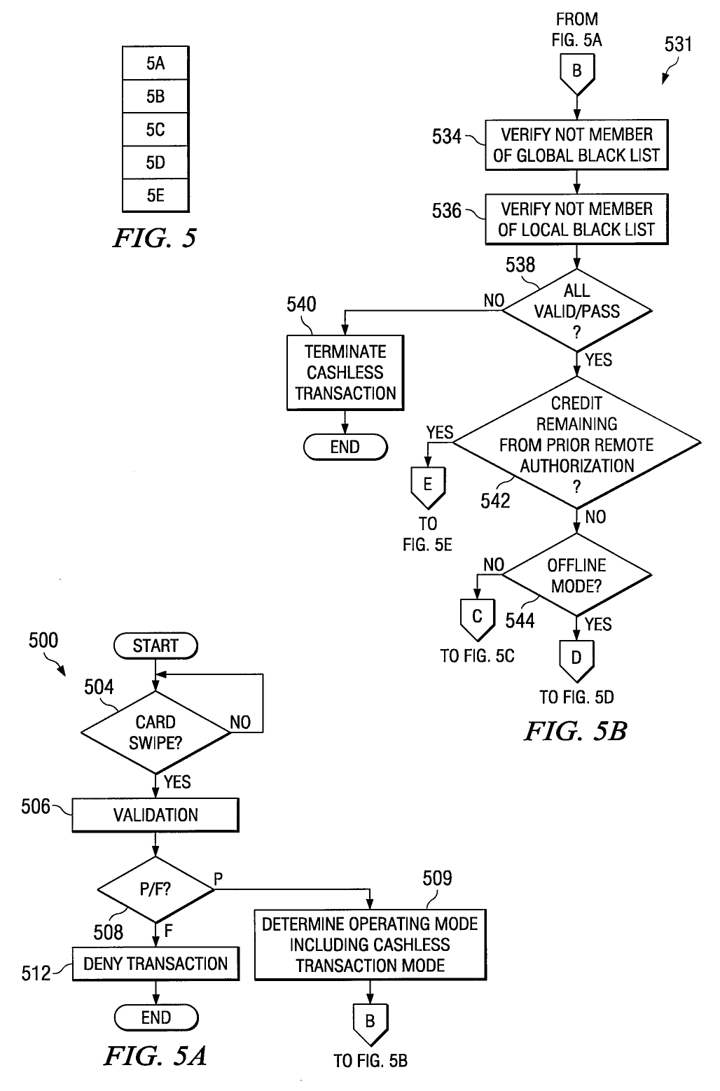

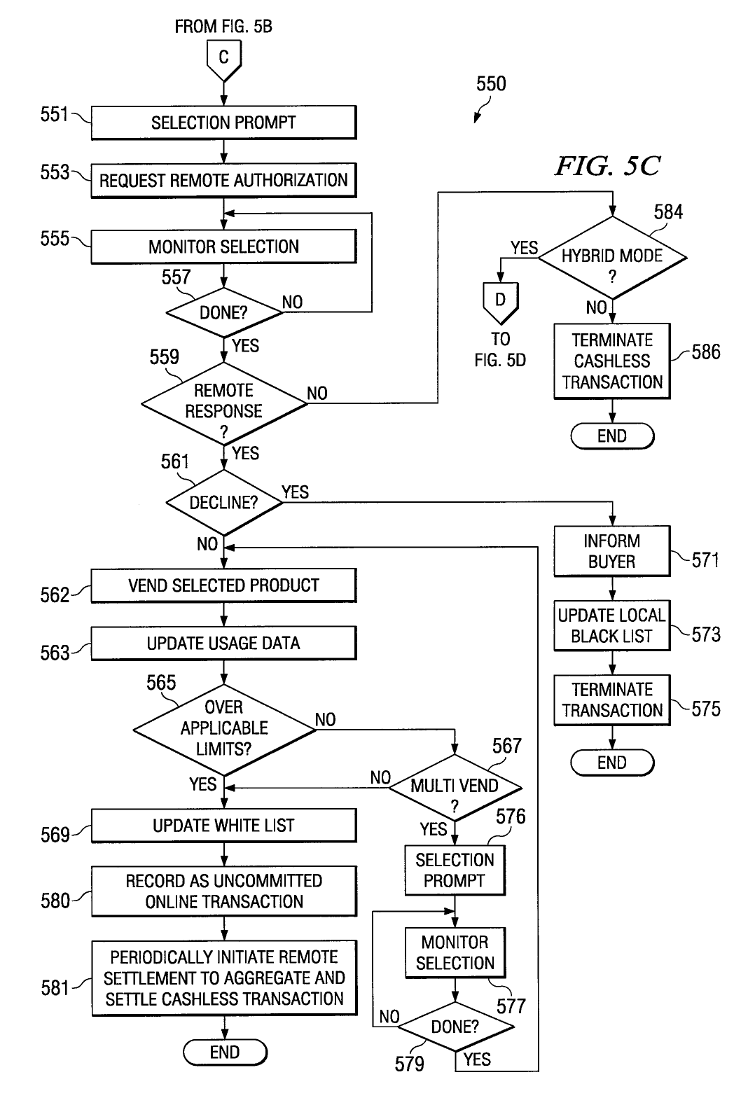

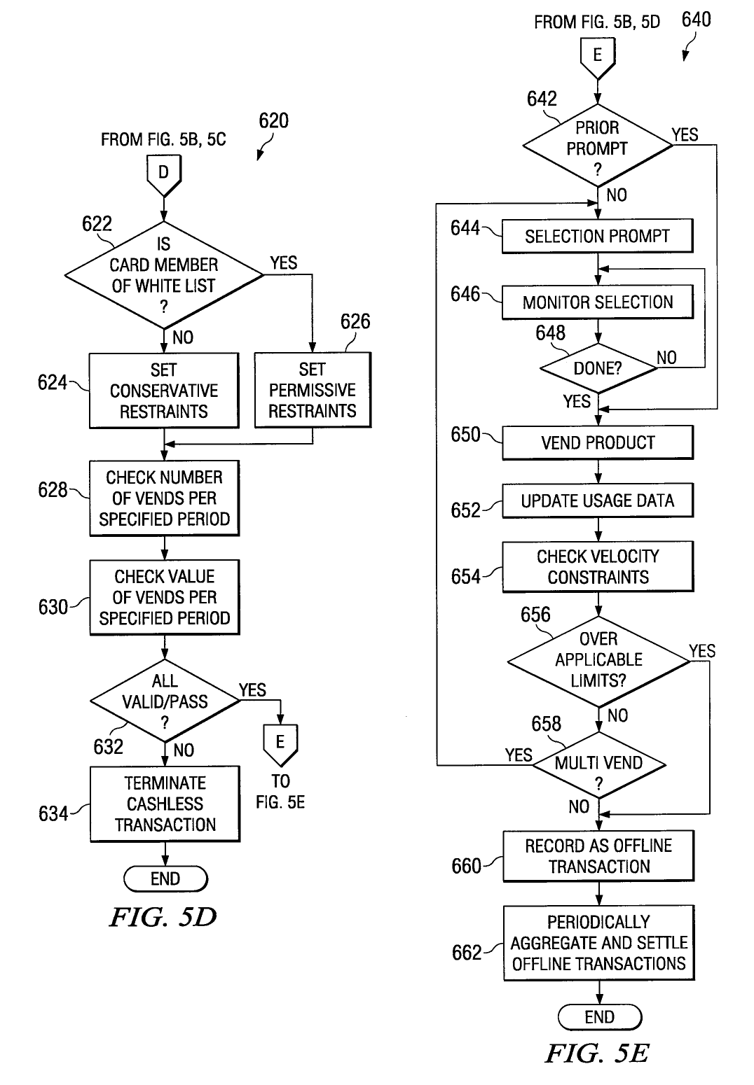

As indicated previously, some elements of the cashless transaction processing described herein may be implemented in software, firmware, or a combination thereof. With respect to field asset 102 generally and EFA 200 more particularly, embedded processor 301 may execute instructions stored in flash 304, memory 306, a combination of the two, and/or from memory that is internal to processor 308 (e.g., the PXA270 includes 256K of internal SRAM). The instructions may also be stored on a persistent and/or portable storage medium such as a optical disk (CD or DVD), a magnetic tape, floppy disk, hard disk, and/or the like. When executed by a processor such as embedded processor 301, the instructions may cause the processor to perform a transaction processing method described in greater detail below with respect to FIG. 5.

Returning now to a description of cashless transaction processing features, cashless agent 201 may represent functionality that facilitates cashless transactions. Cashless agent 201 may include any combination of hardware, software, and firmware. Software and firmware include computer executable instructions, stored on a computer readable medium, such as a flash memory device, ROM, magnetic hard disk, CD, DVD, volatile memory (e.g., DRAM or SRAM) and/or the like.

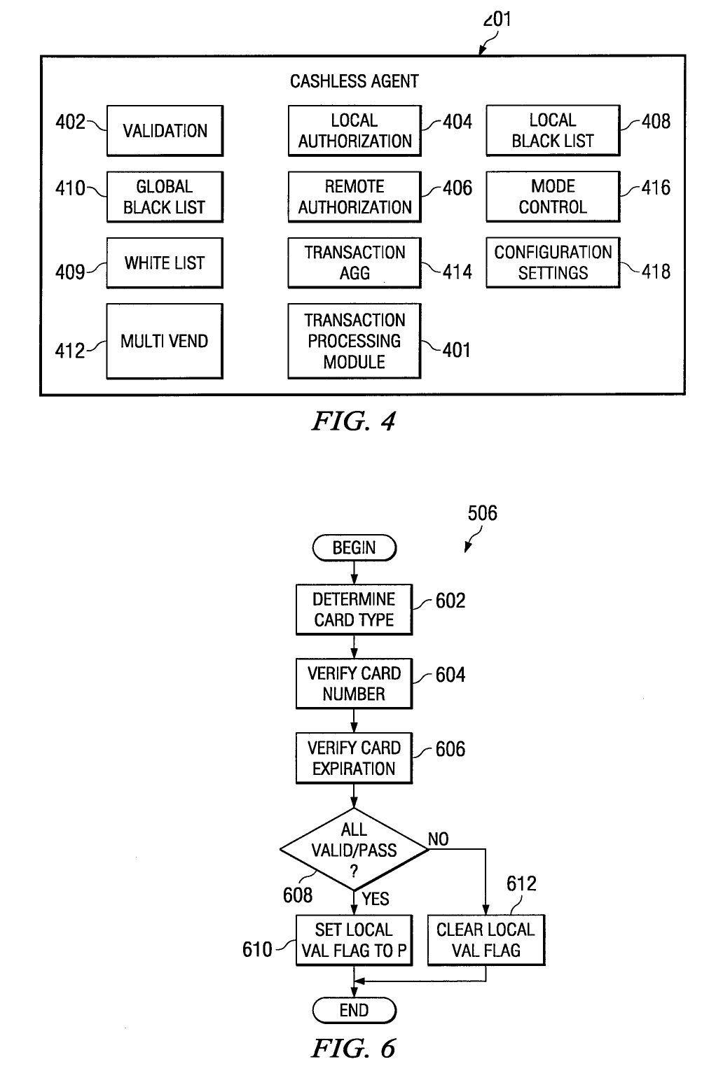

Referring now to FIG. 4, a conceptual representation emphasizing selected cashless transaction processing elements of cashless agent 201 are depicted. In addition to providing card reader support, cashless agent 201 may include additional features or elements that facilitate cashless transaction processing. As depicted in FIG. 4, for example, cashless agent 201 may include a transaction processing module 401, a validation module 402, a local authorization module 404, a remote authorization module 406, a local blacklist 408, a global blacklist 410, a whitelist 409, a multivend module 412, a transaction aggregation module 414, a mode controller 416, and configuration settings 418.

Transaction processing module 401 may represent a transaction processing sequence executed by cashless agent 201 following initiation of a cashless transaction. Transaction processing module may invoke or retrieve information from elements 402 through 418 depicted in FIG. 4. Transaction processing module 401 may begin to execute, for example, whenever card reader 203 detects presentment of a cashless payment card (e.g., a card swipe).

Validation module 402 may provide an initial verification of a card or other media presented for payment of a cashless transaction. Validation module 402 may execute locally and may not rely on any form of remote connectivity. Validation module 402 may represent a module that determines whether the credit card itself, or other form of card, complies with specified constraints. Credit cards, for example, typically include an expiration date that is embossed on the front of the card and embedded as data in a magnetic data strip on the reverse side of the card. Validation module 402 may, for example, determine whether a card presented for payment has expired by accessing the expiration data associated with the card.

Local authorization module 404 and remote authorization module 406 may refer to modules conducting local and remote forms of determining whether an otherwise valid credit card or other form of payment, as determined by validation module 402, is authorized by its issuer to engage in cashless transactions. Authorization of an otherwise valid credit card may occur, for example, if the amount of credit authorized for the card has been exceeded, the card holder has reported the card lost or stolen, or the card issuer is declining the transaction or has recently declined a transaction made under the same credit card.

Whereas remote authorization via remote authorization module 406 may require connectivity to TPS 110, local authorization via local authorization module 404 may occur locally and may provide field asset 102 with a higher level of availability than may otherwise be available. If, for example, the remote connectivity of a field asset 102 is intermittent due, as an example, to the physical location of a field asset within a building, local authorization 404 may enable cashless vending transactions to occur more reliably.

Local blacklist 408, global blacklist 410 and whitelist 409 may be used in conjunction with local authorization module 404 and remote authorization module 406. Whitelist 409 may include, as an example, a list of credit cards known to be “good,” where a good card refers to a card for which a previous cashless transaction has been processed successfully. Local blacklist 408 and global blacklist 410 may include, as examples, a list of credit cards known to be “bad”, where a bad card refers to a card for which a previous cashless transaction bas been declined or otherwise failed to process successfully.

The blacklists 408 and 410 may include cards that have exceeded their credit limit, cards that have been declared lost or stolen, cards that are in serious delinquency, and so forth. Global blacklist 410 may be maintained by TPS 110 and may be distributed from time to time to each field asset 102 in M2M network 100. TPS 110 may transmit the current global blacklist 410 to all field assets 102 via a handheld 130 or directly via wireless connectivity to field assets 102 capable of remote wireless connectivity. By regularly updating the global blacklists on a network-wide basis, M2M network 100 may incorporate locally available data from which cards known to have bad history can be denied without regard to the presence of an online connection.

Mode controller 416 of cashless agent 201 may enable a field asset to operate in one or more operating modes. The operating modes, for example, may depend on the availability of remote connectivity. A field asset 102 may support an “online” mode in which cashless transactions may occur only when remote connectivity is present. Field asset 102 may also support an “offline” mode in which cashless transactions are permitted without regard to the status of remote connectivity. Moreover, field asset 102 may support a “hybrid” mode that permits some transactions when remote connectivity is present and permits other transactions when remote connectivity is not present.

Cashless agent 201 as depicted in FIG. 4 may further include a multivend module 412 and a transaction aggregation module 414. Multivend module 412 may support enabling a consumer to make multiple cashless transactions with a single swipe, i.e., a single authorization request. Transaction aggregation module 414 may support the aggregation of multiple transactions for purposes of submitting a single remote authorization. By aggregating transactions field asset 102 and submitting aggregated authorization requests to TPS 110, transaction aggregation may potentially reduce transaction costs associated with submitting transactions for authorization to credit card issuers, banks, and others. The configuration settings 418 depicted in cashless agents 201 represent registers, flags, memory locations, and the like whose value may influence the behavior of the other modules. Mode control 416, for example, may access a mode setting in configuration settings 418 to determine in what mode the system exists.

Referring now to FIG. 5, which includes FIGS. 5A through 5E, a flow diagram illustrates one embodiment of a cashless transaction processing method 500. Cashless transaction processing method 500 may represent computer executable software instructions that are stored on a computer readable medium. The instructions, when executed by a processor such as embedded processor 301 of EFA 200, may cause cashless agent 201 to perform method 500.

The elements of method 500 emphasized in FIG. 5 are directed to facilitating cashless transactions in vending machine applications. Cashless transactions may be facilitated by the described method and software in multiple different ways including, by way of example, by reducing the perceived latency of online cashless transactions and by providing a cashless vending environment and paradigm able to take advantage of an online connection when present, but also able to continue to operate when online connections are intermittent, noisy, lossy, or otherwise unstable. Moreover, the described methods and software benefit vending providers directly by implementing a sales aggregation technique that has the potential to reduce cashless transaction costs, including credit card transaction costs.

As depicted in FIG. 5, cashless transaction method 500 is shown as beginning in a looping state in which field asset 102 monitors for the initiation of a cashless transaction. In the depicted embodiment, initiation of a cashless transaction may begin when field asset 102 and, more specifically, card reader 203 detects (block 504) the “swipe” of a credit card or other form of cashless payment (e.g., debit card, pre paid smart card, RFID cards, proprietary magnetic stripe cards, hotel room key cards, etc.).

Upon detecting a swipe at block 504, method 500 as depicted in FIG. 5A may initiate one or more validation and/or authorization sequences and makes one or more decisions based on outcome(s) of the validation and/or authorization sequence(s). As depicted in FIG. 5, the card that is swiped in block 504 may be subjected to validation 506.

Validation 506 may occur locally on field asset 102 and therefore without regard to any remote connectivity, e.g., without regard to real time connectivity between field asset 102 and TPS 110 or to a third party database or server, e.g., the database or server of a commercial credit card issuer.

Referring momentarily to FIG. 6, a flow diagram illustrating selected elements of an embodiment of validation 506 is depicted. In the depicted embodiment, validation 506 may include determining (block 602) the type of card that was detected by card reader 203. Card type determination may include determining information indicating whether the swiped card is a credit card, merchant card, debit card, smart card, RFID card, and so forth. Card type determination may further include determining the bank or other issuer of the credit card and possibly an association of the card with a credit card brand (e.g., VISA, MASTERCARD, AMERICAN EXPRESS, DISCOVER, etc.).

Validation 506 may further include performing a base-level security check of the swiped card. In the embodiment depicted in FIG. 6, for example, validation 506 may include verifying (block 604) that a credit card number associated with the card is a valid card number. Credit cards, for example, include a number, usually referred to as the card number or account number. The card number frequently contains between fifteen and seventeen digits and is embossed on the front of the card. Frequently, the first six digits of a credit card number comprise a bank identification number (BIN) identifying the issuing bank of the credit card. The remaining digits of a credit card may comprise an individual account number of the cardholder.

Verifying the card number in block 604 may also include determining a checksum based on the all or portions of the card number and possibly other information contained in or on the card (e.g., a security number). The calculated checksum may be examined for compliance with an industry standard or credit card issuer standard for checksums. If the locally determined checksum does not comply with the applicable standard, the card is rejected as fraudulent and validation fails.

Validation 506 may still further include verifying (block 606) an expiration date and possibly other card information that may be stored on the card's magnetic strip. Any such information retrieved may be verified against known values or standards. A card having an expiration date that is earlier than the current date, for example, would cause validation to fail.

Validation 506 as depicted may further include documenting or recording information indicative of a result of validation 506. As depicted in FIG. 6, for example, a pass/fail result of validation 506 is recorded by setting (block 610) or clearing (block 612) a validation flag depending upon whether validation 506 passed or failed.

Returning to FIG. 5A, the depicted embodiment of cashless transaction processing method 500 may follow the completion of validation 506 by making a decision (block 508) based on the result of the validation. If validation fails, the cashless transaction may terminate at block 512. In some embodiments, the denial of a cashless transaction may include communicating the denial to the consumer. A field asset may, for example, flash a message on the LED screen conveying the denial and possibly prompting the consumer to use a different form of payment, which may be cash or another form of cashless payment.

If validation 506 passes, however, cashless transaction processing method 500 as depicted may include determining (block 509) an operating mode of field asset 102. The determination of an operating mode in block 509 may include determining a cashless transaction mode in which the field asset is operating. Some embodiments of field asset 509 may support multiple cashless transaction modes.

The cashless transaction modes may determine at least some aspects the cashless transaction processing behavior of the field asset 102. In some embodiments, for example, the cashless transaction modes and the corresponding cashless transaction processing behavior of a field asset may reflect the availability of remote connectivity. Various cashless transaction modes of a field asset 102 are discussed in greater detail below.

In at least some embodiments, cashless transaction processing module 500 may support multiple cashless transaction processing modes. In the embodiments described herein, the cashless transaction processing mode may include an online mode, an offline mode, and an online/offline mode also referred to herein as hybrid mode. The various modes may implement various levels of control over cashless transaction processing.

Maximum control over cashless transactions, for example, may be achieved in the online mode, where cashless transactions are prohibited or greatly restricted when remote connectivity is unavailable to a field asset 102. Offline mode, in contrast, may refer to an operating mode in which cashless transactions are permitted without regard to remote connectivity, and may be subject to locally determined constraints. In hybrid mode, a field asset may operate as if in an online mode when remote connectivity is available and as if in an offline mode when remote connectivity is absent. Regardless of the cashless transaction mode, at least a portion of each cashless transaction may be processed locally on field asset 102. Thus, after determination of the cashless transaction processing mode in block 509, method 500 may proceed to an offline processing module described with respect to FIG. 5B.

Referring now to FIG. 5B, an embodiment of an offline processing module 531 of cashless transaction processing module 500 is depicted. Offline processing module 531 may be executed when a swiped card is validated and field asset 102 is operating in an any cashless transaction processing mode (offline, online or hybrid). Initially, a check may be made (block 534) of whether the card is present on global blacklist 410. In addition, a second check may be made (block 536) of whether the card is present on local blacklist 408. In some embodiments, these checks may be redundant of checks already performed by cashless transaction processing module 500 and may be eliminated. Even if redundant, blocks 534 and 536 may be retained to provide an additional level of security for the field asset operator. At block 538, a determination may be made of whether the card appears on either blacklist, meaning that the card is a known “bad” card. If the card is a known bad card, cashless transaction authorization may be denied and cashless processing may terminate (block 540).

The checks made in blocks 534 and 536 prevent a holder of a known bad card from repeatedly swiping the card in a machine that is operating in its online or hybrid mode and thereby incurring charges for each unsuccessful attempt to authorize the card remotely. In an alternative embodiment, online/hybrid processing module 550 (see FIG. 5C) could simply prevent known bad cards from participating in cashless transactions.

Assuming the card is not a known bad card, offline processing module 531 may determine at block 542 whether or not sufficient pre-authorized credit amount remains for the card in connection with a prior online remote authorization. As discussed in greater detail below, a pre-authorized credit amount may exist at field asset 102 for a card, if, at some time prior to the present transaction, the card is used at the same field asset 102 in a transaction for which an online authorization was requested and approved. To illustrate, whenever field asset 102 requests an online authorization and such authorization is approved, the authorization amount may be determined by a configuration setting and may be greater than the price of the most expensive item sold by the field asset. Any authorized amount may not be immediately charged to the cardholder's account, but rather, all or a portion of the authorized amount may be charged to the cardholder's account at such time as the authorization is settled and/or committed. The time of settling and/or committing may be determined by a configurable setting and may vary from a few hours after authorization to even days after authorization.

Therefore, if during a single transaction, the authorization amount exceeds the aggregate price of products purchased with a card, such unused portion of the authorization amount may temporarily remain as a “credit” for such card until the authorization is settled and/or committed. Accordingly, a single authorization of a card at field asset 102 may, in certain instances, support multiple non-contemporaneous swipes of a card and purchases made in connection with such multiple swipes. Because of transaction costs associated with each authorization of a card, allowing subsequent card swipes to “piggyback” onto an earlier authorization may reduce transaction costs associated with cashless vending purchases.

Turning back to FIG. 5B, if the determination at block 542 determines pre-authorized credit amount remains, execution of cashless transaction processing module 500 may pass to a vending module 640 depicted in FIG. 5E. Otherwise, offline processing module 531 may determine (block 544) whether field asset 102 is operating in offline mode. If field asset 102 is in offline mode, execution of cashless transaction processing module 500 may pass to a velocity restraints module 620 depicted in FIG. 5D. If field asset 102 is not in offline mode, execution of cashless transaction processing module 500 may pass to an online/hybrid processing module 550 depicted in FIG. 5C.

Referring now to FIG. 5C, a online/hybrid processing module 550 of cashless transaction processing module 500 is depicted. The depicted embodiment of offline online/hybrid processing module 550 incorporates a number of features that facilitate cashless transactions and cashless transaction processing. Online/hybrid processing module 550, for example, incorporates the concept of reducing the perceived latency of online cashless transactions, i.e., cashless transactions that require remote authorization. In addition, online/hybrid processing module 550 supports multivend operation and transaction aggregation.

Online hybrid processing module 550 may begin at block 511 where a consumer, purchaser, or other user of field asset 102 may be prompted for a selection. In the case of vending machines, for example, selection prompt 511 may prompt the consumer to select a product. As previously discussed, online authorization of credit card purchases may require significant time as the vending machine may be required to communicate, with a remote database, for example, a database maintained by the credit card issuer. However, vending machine customers generally expect no or very little latency in conjunction with a purchase. Accordingly, the sequence depicted in FIG. 5C may minimize the perceived latency associated with remotely authorized transactions by initiating a request (block 553) for remote authorization immediately upon prompting the user for his or her selection. In this manner, the time required to remotely authorize a transaction may occur while the user is deciding on a product selection.

After the remote authorization request is initiated, field asset 102 may monitor for a product selection in blocks 555 and 557. When the user has made a product selection, online/hybrid processing module 550 may then check (block 529) the status of the remote authorization request by determining if a response to the request has been received. If remote connectivity is available, online/hybrid processing module 550 may remain at block 559 until a remote response is received. If a remote response is not received, for example, if remote connectivity is not available, online/hybrid processing module 550 may branch to block 584 (discussed below).

If and when a response has been received, the response may be checked (block 561) to see if the authorization request was declined or granted. If the remote authorization was declined, the user may be informed (block 571) via a display on the field asset, local blacklist 408 may be updated (block 573) to reflect the swiped card as a known bad card, and cashless transaction processing may terminate at block 575.

Returning to block 561, online/hybrid processing module 550 may cause field asset 102 to dispense the selected product, and may proceed to update (block 563) usage data for the swiped card if the authorization request is granted. The usage data may refer to locally stored data indicative of, for example, the frequency and dollar amount of usage of a particular card. The usage data may constitute a portion of blacklists 408 and 410 and whitelist 409. Each entry in whitelist 409, for example, may include information from which field asset 102 can determine how many times the card has been used for a transaction and how much money has been accumulated for the card. For “unknown” cards, i.e., cards that are in none of whitelist 409 and blacklists 408 and 410, field asset 102 may create records for each unknown card to track the usage data associated with an unknown card. Usage data may also comprise the authorization amount of the remote authorization and/or an entry for any “unused” amount of the authorization, such that any such unused portion may be utilized as pre-authorization credit as detailed above with respect to block 542 of offline processing module 531. In the same or other embodiments, usage data may also keep track of how many products have been dispensed during a multivend transaction (discussed in greater detail below).

The usage data may then be checked (block 565) against any applicable limits. For example, if the limits (for example, multivend limits) have not been exceeded, a multivending determination may be made in block 567.

Multivending refers to the ability to permit a consumer multiple vends for a single card swipe. A field asset 102 may include a configuration setting indicating the number of transactions permitted for each card swipe. A single authorization, either local or remote, may be given. The authorization amount may be determined by the multivending configuration setting. If the configuration setting permits, for example, three transactions per card swipe, the amount authorized might be equal to 3× MAXPRICE, where MAXPRICE is a configuration setting equal to the price of the most expensive item sold by the field asset. Although each separate transaction in a multivending transaction may be treated as a separate transaction by the vending machine hardware such as the VMC, e.g., each transaction may include an MDB session start and an MDB session end, the multiple transactions may be recorded and settled as a single transaction.

If the multivend configuration setting is greater than one, field asset 102 is said to be in a multivend mode and users may be prompted to indicate whether they wish to make another selection. If multivending is enabled and the user elects another transaction, execution may branch to block 576 where a selection prompt is displayed. Field asset 102 may then monitor for a selection in blocks 577 and 579. When the selection is made, execution may branch to block 562 where another selected product may be dispensed, and may again proceed to block 563 where the usage data may again be updated. If, usage data check in block 565 is over or otherwise exceeds the applicable limits (for example multivend limits), then execution may branch to block 569 where whitelist 409 may be updated to indicate that the card used to make the purchase is a known “good” card. Execution may continue to block 569 where the transaction may be recorded as an uncommitted online transaction. Periodically, remote settlement may be initiated and the recorded transactions may be aggregated and settled (block 581).

As detailed above, if remote connectivity is not available at block 559, execution may proceed to block 584 where a determination is made to determine whether or not field asset 102 is in hybrid mode. If in hybrid mode, cashless transaction processing module 500 may proceed to velocity restraints module 620 depicted in FIG. 5D. Otherwise, field asset 102 is in online mode and thus may not be permitted to locally authorize a cashless transaction. In such a situation, execution may terminate at block 586.

As discussed above, transactions executing in offline and hybrid modes may proceed to velocity restraints module 620. Turning to FIG. 5D, velocity restraints module 620 may begin by making a determination as to whether the card swiped is a member of whitelist 409, indicating that the card swiped is a known “good” card—a card swiped at remote asset 102 that has previously been approved during a remote authorization and/or settling of offline transactions. Velocity restraints module 620 may distinguish between known good and unknown cards by applying different constraints on use of the card. These constraints may include “velocity” constraints such as the velocity constraints discussed below. Known good cards may be checked (block 626) against a permissive set of constraints while unknown cards may be checked (block 624) against a conservative set of constraints.

Velocity restraints module 620 may verify that a facially valid card, i.e., a card which has passed validation (block 506), is not in conflict with one or more specified constraints on use of the card. In some embodiments, for example, velocity restraint module 620 may include checks against specified spending velocity constraints, where spending velocity constraints refer to limits on the frequency and amount of use of the card that may occur during a specified time period. Providing support for spending velocity limits may facilitate and promote the use of cashless transactions by enabling cashless vending during periods when remote connectivity may not be available to obtain remote authorization, e.g., authorization from the card issuer. When remote connectivity is not available, velocity checks and other safeguards included in velocity restraint module 620 may reduce the loss exposure for the field asset operator.

Referring again to FIG. 5D, velocity restraint module 620 may include a first velocity check (block 628) in which the frequency of use of the card is compared to a frequency of use limit. The frequency of use limit may be a value stored in field asset 102 that serves as an upper limit on the number of vend transactions that may be accepted for a card in a specified period without regard to the value (dollar amount) of the transactions. A typical frequency of use limit might restrict use of the card to N transactions in X hours. The values for N and X may be altered from time to time and may be determined or set by transaction processing server 110 and provided to a field asset from time to time when, for example, a handheld unit is used in conjunction with a field asset to transfer information. This implementation promotes uniformity of the velocity limits. Alternatively, the values of N and X might be modified locally by a field asset operator to support locally determinable velocity limits.

As indicated previously, the use constraints, as reflected by the values of N and X, may depend on a status or categorization of the card that is swiped. In the embodiments described herein, for example, swiped cards may be classified as known good (e.g. a card on whitelist 409), known bad (e.g. a card on either of blacklists 408 and 410), and unknown. The conservative velocity limits applied to an unknown card, for example, may be more restrictive than the permissive velocity limits applicable for a known good card. A known good card might, for example, warrant a velocity limit of 10 vends per 96 hours while an unknown card may be limited to 4 vends per 96 hours. Of course, these specific values are implementation details and may be altered as needed to suit a particular situation. Moreover, cashless transaction processing module 500 may support various levels of known good cards to support, as an example, different classes of known good cards. Frequent known users might then be classified as such and be awarded an even more permissive set of use constraints.

Velocity restraints module 620 as depicted in FIG. 5B may further include a second velocity check (block 630) that checks the value, e.g., dollar amount, of transactions during the specified period. Like the frequency of use limits checked in block 702, the dollar amount limits for the second velocity check of block 704 may be alterable and may depend on the category of card used in the transaction. Thus, for example, a known good card may have permissive spending limits, e.g., 20 dollars per 96 hours while an unknown card may be limited to a more conservative figure, e.g., 8 dollars per 96 hours.

After performing all of the velocity restraint checks, velocity restraints module 620 may determine (block 632) whether any of the velocity restraint checks failed. If all velocity restraint checks pass, cashless transaction processing module 500 may proceed to offline vending module depicted in FIG. 5E. Otherwise, the cashless transaction may terminate at block 634. The depicted embodiment of local authorization depicts blocks 628 and 630 arranged in an unconditional serial fashion, i.e., there are no branches into or out of the series of blocks 628 and 630. Other embodiments may incorporate decision steps after block 628. In such embodiments, velocity restraints module 620 may terminate the cashless transaction immediately upon any of the blocks 628 or 630 failing.

Referring to FIG. 5E, an embodiment of offline vending module 640 is depicted. The depicted embodiment of offline vending module 640 may incorporate a number of features that facilitate cashless transactions and cashless transaction processing. For example, vending module 640 may support multivend operation and transaction aggregation.

The embodiment of offline vending module 640 depicted in FIG. 5D may determine (block 642) whether or not the user has responded to a prior selection prompt for which cashless transaction processing module 500 has not completely processed. Such may be the case if field asset 102 is in hybrid mode and remote connectivity is not available (see, e.g., blocks 551, 553, 555, 557, 559 and 584 of FIG. 5C). If such a prior selection has been made by a user, offline vending module 640 may proceed to block 650, discussed below. Otherwise, offline vending module 640 may prompt (block 644) the consumer, purchaser, or other user of field asset 102 for a selection. In the case of vending machines, for example, selection prompt 644 may prompt the consumer to select a product.

After prompting the consumer, offline vending module 640 may monitor (block 646) field asset 102 to determine whether the user has made a selection. Until the user makes a selection, as determined in block 648, offline vending module 640 may loop on the selection monitoring of block 646 and 648.

When the user makes a selection, offline vending module 640 may cause field asset 102 to dispense the selected product (block 650) and may update (block 652) usage data corresponding to the card. The usage data may refer to locally stored data indicative of, for example, the frequency and dollar amount of usage of a particular card. The usage data may constitute a portion of blacklists 408 and 410 and whitelist 409. Each entry in whitelist 409, for example, may include information from which field asset 102 can determine how many times the card has been used for a transaction and how much money has been accumulated for the card. For “unknown” cards, i.e., cards that are in none of whitelist 409 and blacklists 408 and 410, field asset 102 may create records for each unknown card to track the usage data associated with an unknown card. Usage data may also comprise the authorization amount of the remote authorization and/or an entry for any “unused” amount of the authorization, such that any such unused portion may be utilized as pre-authorization credit as detailed above with respect to block 542 of offline processing module 531. In the same or other embodiments, usage data may also keep track of how many products have been dispensed during a multivend transaction.

After updating usage data, offline vending module 640 as depicted in FIG. 5E may check (block 654) the card against the appropriate set of constraints, e.g., unknown cards may be checked against conservative constraints while known good cards (e.g. cards on whitelist 409) may be checked against permissive constraints. If (block 656) a card has exceeded its constraints, either in terms of the number of amount of uses, or if it has exceeded other applicable usage limits (e.g., exhaustion of any pre-authorized credit amount) execution may branch around a multivend decision and may record (block 660) the transaction as an offline transaction and may later aggregate and settle (block 662) recorded offline transactions. If the constraints and applicable limits are not exceeded in block 656, a multivend determination is made in block 658. If in multivend mode and the user has not made the maximum number of vends allowed, offline vending module 640 may again proceed to block 644 where the user may be prompted to select another product. Otherwise, execution may proceed to block 660 (described above).

In the embodiment of cashless transaction processing module 500 depicted in FIG. 5, it is evident that the offline mode of cashless transaction processing module 500 may prevent cashless transactions when local authorization fails regardless of the availability of remote authorization. In other embodiments (not depicted), the offline processing mode might include determining the status of remote connectivity prior to abandoning cashless transactions when local authorization fails. Furthermore, as depicted in FIG. 5, the online mode of cashless transaction processing module 500 may permit cashless vending only when remote connectivity is or can be established between field asset 102 and transaction processing server 110. If remote connectivity is not available and field asset 102 is operating in online mode, field asset 102 may operate as a cash only machine. In the described implementation of the hybrid mode, cashless transaction processing module 500 may execute in online mode if remote connectivity is available, but may revert to offline processing when remote connectivity is absent.

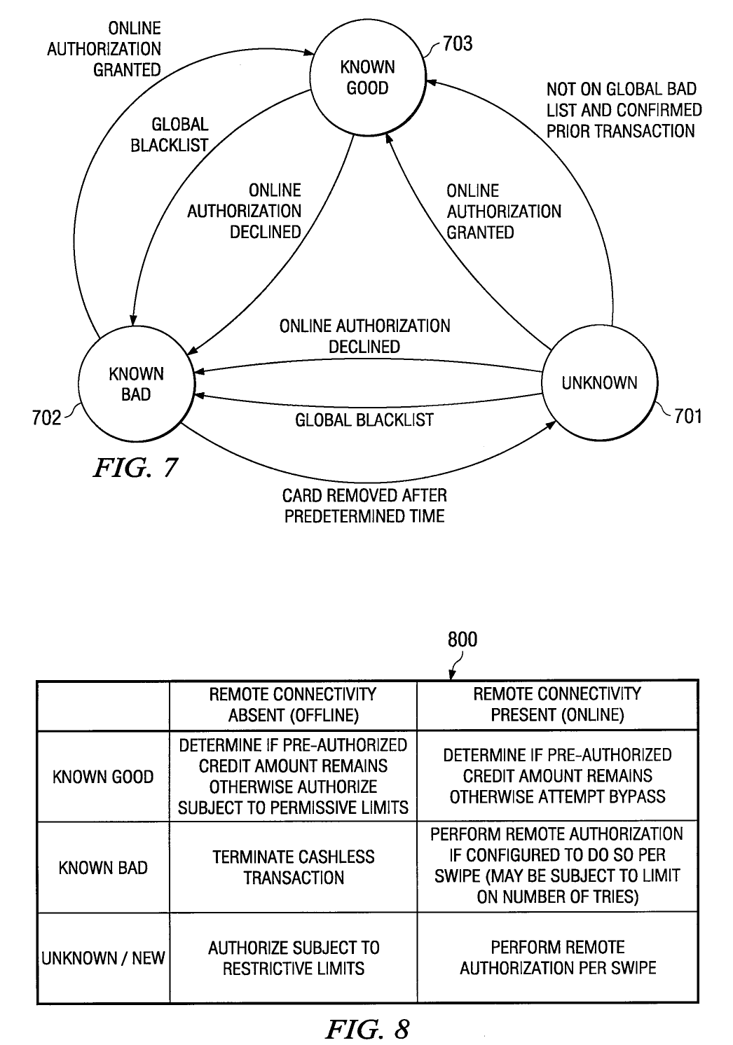

Although not depicted above, cashless transaction processing module 500 may elect to facilitate cashless transactions by giving known bad cards (e.g. cards listed on blacklists 408 and/or 410) at least one opportunity to obtain a remote authorization. A card, for example, may have been placed on the known bad list when a transaction was attempted and declined at a time when the card had a past due balance or was over its authorized spending limit. If payment is received thereby enabling the card issuer to authorize subsequent transactions, online/hybrid processing module 550 as depicted may be modified to permit the card to engage in a cashless transaction if remote authorization is obtainable. In this way, online/hybrid processing module may enable a card to transition from a known bad state to a known good state as discussed in greater detail below with respect to FIG. 7.

Also, although not depicted above, cashless transaction processing module 500 may elect to facilitate cashless transactions by removing known bad cards (e.g. cards listed on blacklists 408 and/or 410) from their respective blacklists after a predetermined time. In some embodiments, the predetermined time by be configurable by the operator of field asset 102. A card, for example, may have been placed on the known bad list when a transaction was attempted and declined at a time when the card had a past due balance or was over its authorized spending limit. After a predetermined time, a cardholder may have cured defaults associated the card, and a card may be removed from a blacklist thus allowing the cardholder to use the card.

The described embodiment of field asset 102 and cashless transaction processing module 500 according to one implementation may include support for transaction aggregation that facilitates a reduction in costs associated with processing cashless transactions. In one implementation, transaction aggregation module 414 may be responsible for gathering recorded cashless transactions. From time to time, the record transactions may be transferred to TPS 110, either via wireless network 120 or via hand held 130 and local wireless network 140.

Upon receiving recorded transactions, TPS 110 may issue a receipt of delivery to hand held 130 or directly to field asset 102 via wireless network 120. In the former case, the receipt may be delivered back to server 102 when hand held 130 is next in proximity to the corresponding field asset. The receipt may provide confirmation that the recorded transactions were received by TPS 110.

Transaction cost reduction may be achieved in transaction aggregation module 414 by an informed process for determining when to send transactions off to the third party credit card issuers for confirmation and payment. The informed decision may include, as an example, aggregating transactions by credit card number and submitting aggregated transactions for processing to spread the transaction costs across multiple transactions. As previously explained, credit card transaction costs include a fixed component that becomes prohibitively expensive for low price point items and aggregating transactions helps to reduce the transaction costs.

The aggregation of transactions may continue until a criteria for submitting transactions to a credit card issue is satisfied. The criteria might include, in one implementation, a max dollar criteria in which the dollar amount of the aggregated transactions for a particular card exceeds a threshold. Such a threshold might be set as a multiple of the cost of the most expensive item offered in a field asset. In addition, an age criteria might be applied to the bundled transactions such that, for example, transactions are automatically processed or submitted for processing when the number of days any of the aggregated transactions has been pending exceeds an age threshold.

Turning now to FIG. 7, a state diagram illustrates the categories or states of cashless payment cards that a field asset may recognize and the paths for transitioning from one category or state to another according to some embodiments is depicted. The depicted embodiment is representative of an EFA 200 that includes a one or more lists (e.g. local blacklist 408, global blacklist 410 and whitelist 409) capable of identifying three categories of cashless payment cards, namely known “good” cards as indicated by state 701, known “bad” cards as indicated by state 702, and unknown cards as indicated by state 703.

The first time a cashless payment card is ever used on a field asset, it is most likely an unknown card, i.e., the card is not identified in the known good or known bad lists. As depicted in FIG. 7, an unknown card may be a known good card (and thus added to whitelist 409) in at least two different ways. The first is if the unknown card is used on a field asset that successfully authorizes the transaction remotely. Successful remote authorization may cause the cashless payment card to be listed as a known good card and added to whitelist 409. Similarly if an unknown card is not identified in a global known bad list and at least one transaction (online or offline) can be confirmed, the unknown card may transition to the known good state and may be added to whitelist 409.

In contrast, an unknown card may transition to the known bad list if a remote authorization attempt is unsuccessful or the card appears on a global blacklist distributed by the transaction processing server. A known bad card, as illustrated in FIG. 7 may transition to an unknown card state if the card is removed from blacklists 408 and/or 410 after a predetermined period of time as discussed above.

A known bad card may transition to a known good card state in those embodiments allowing a remote online authorization attempt of a known bad card. A known good card, on the other hand, may transition to a known bad state if the card appears on the most recently received global blacklist or if an online authorization is attempted and fails.

Turning now to FIG. 8, a table 800 illustrates the concept of a field asset having an EFA 200 that supports multiple transaction processing modes, e.g., the online and offline transaction process modes depicted in Table 800. In the depicted embodiment, the field asset EFA 200 may perform transaction processing based on a combination of the transaction processing mode and the categorization of the particular cashless payment card as either known good, known bad, or unknown.

When EFA 200 is in an offline transaction processing mode, or a hybrid mode when remote connectivity is negative or absent, it may be determined whether pre-authorized credit amount remains on known good cards; otherwise known good cards may be locally authorized using permissive limits on use parameters, i.e., frequency of use of the cards and cumulative value of purchases made with the cards, while unknown cards may be locally authorized subject to more restrictive limits. Known bad cards may cause cashless transaction processing to abort when EFA 200 is in an offline processing mode.

When EFA 200 is in an online transaction processing mode, or a hybrid mode when remote connectivity is positive or present, unknown cards may be remotely authorized on a per-swipe basis. A known bad card may be remotely authorized in those embodiments where EFA 200 is configured to make at least one remote authorization attempt for a known bad card, and may be subject to a limit on the number of attempts it can make to prevent a known bad card from incurring significant charges associated with multiple unsuccessful remote authorizations. In the depicted embodiment, it may be determined whether pre-authorized credit amount remains on known good cards; otherwise known good cards are authorized remotely. Other embodiments may require even known good cards to undergo remote authorization when EFA 200 is in online or hybrid mode.

What is claimed is:

1. A method of processing transactions, comprising:
detecting, by a field asset, initiation of a cashless transaction and, in response:
determining a cashless transaction processing (CTP) mode of the field asset; and
determining authorization for the cashless transaction based at least in part on the CTP mode and a remote connectivity status (RCS) of the field asset.

2. The method of claim 1, wherein said RCS is indicative of connectivity between the field asset and a remotely located transaction processing server.

3. The method of claim 1, wherein said detecting comprises detecting, by a card reader of the field asset, presentment of a cashless payment card.

4. The method of claim 1, wherein said CTP mode is selected from a set of modes consisting of an offline mode and an online mode.

5. The method of claim 4, wherein determining said authorization includes:
performing local authorization if said CTP mode is said offline mode, wherein local authorization comprises determining authorization based on transaction information stored locally on the field asset; and
performing remote authorization if said CTP mode is said online mode and said RCS is positive, wherein remote authorization includes communicating with a remotely located transaction processing server.

6. The method of claim 5, wherein the set of modes from which said CTP mode is selected further includes a hybrid mode and wherein determining said authorization when said CTP mode is said hybrid mode comprises performing said local authorization when said RCS is negative and performing remote authorization when said RCS is positive.

7. The method of claim 5, wherein performing said local authorization comprises accessing said locally stored transaction information to determine a value for a parameter indicative of use of a cashless payment card associated with the transaction.

8. The method of claim 7, wherein said parameter is selected from the set of parameters consisting of: a frequency of use parameter indicative of how many times the cashless payment card has been used on the field asset during a specified period and a value parameter indicative of a cumulative value of purchases made with the cashless payment card on the field asset during a specified period.

9. The method of claim 5, wherein performing local authorization includes:
accessing a locally stored list to classify the cashless payment card as a known good card, a known bad card, and an unknown card; and
determining authorization based at least in part on said classifying.

10. The method of claim 9, further comprising updating said locally stored list to reflect a change in a classification of said cashless payment card.

11. The method of claim 10, wherein updating said locally stored list includes: (1) classifying an unknown cashless payment card as known bad responsive to a failed remote authorization associated with the card; (2) classifying an unknown cashless payment card as a known good card responsive to a successful remote authorization associated with the card.

12. The method of claim 9, wherein determining authorization includes comparing a value of a use parameter indicative of use of the cashless payment card in the field asset against a first threshold if said cashless payment card is a known good card and against a second threshold if said cashless payment cards is an unknown card.

13. The method of claim 5, further comprising updating the locally stored transaction information following completion of a cashless transaction and updating the locally stored lists.

14. The method of claim 5, wherein performing remote authorization includes, during a latency associated with said communicating with said remotely located transaction processing server, presenting a user of said field asset with a prompt requesting the user to make a transaction decision.

15. The method of claim 14, wherein presenting the user with said prompt comprises requesting the user to select a product sold by the field asset.

16. The method of claim 5, wherein remote authorization includes obtaining, via the remote transaction server, authorization for the transaction from an issuer of the cashless payment card.

17. The method of claim 5, wherein remote authorization includes, aggregating multiple transactions associated with a single cashless payment card to create an aggregated transaction and remotely authorizing the aggregated transaction as a single transaction.

18. The method of claim 3, further comprising performing validation of the cashless payment card including validating a card number associated with the cashless payment card.

19. The method of claim 18, wherein validation includes validating an expiration date of the card.

20. The method of claim 18, wherein validation includes determining that the card is not identified in a list of known bad cards stored on the field asset.

21. A field asset for use in a machine to machine environment having a plurality of field assets in communication with a remote transaction processing server, the field asset comprising:
a card reader operable to detect a cashless payment card presented to the card reader;
an extended function adapter (EFA) in communication with the card reader and operable to facilitate a cashless transaction in response to said card reader detecting presentment of the cashless payment card to the card reader by:
locally authorizing the cashless transaction based on locally stored transaction information if said field asset lacks connectivity to a remote transaction processing server; and
remotely authorizing the cashless transaction based on remotely stored transaction information if the field asset has connectivity to the remote transaction processing server.

22. The field asset of claim 21, further comprising locally validating the cashless payment card including validating a card number associated with the cashless payment card and an expiration date associated with the cashless payment.

23. The field asset of claim 22, wherein the EFA is further operable to locally maintain a local list including a list of known bad cards.

24. The field asset of claim 23, wherein locally validating the cashless payment card includes determining that the cashless payment card is not on the list of known bad cards.

25. The field asset of claim 24, wherein the local list further includes a list of known good cards and wherein locally authorizing includes determining whether the cashless payment card is a known good card.

26. The field asset of claim 25, wherein locally authorizing includes:
determining from said locally stored transaction information a frequency and cumulative value of transactions associated with the cashless payment card during a specified time interval;
comparing said frequency and cumulative value of transactions to frequency and cumulative value limits respectively; and
authorizing said cashless transaction if said frequency and cumulative value do not exceed said frequency and said cumulative value limits respectively.

27. The field asset of claim 26, wherein said frequency and cumulative value limits have first respective values if said cashless payment card is a known good card and second respective values if said cashless payment card is an unknown card.

28. The field asset of claim 21, wherein the EFA is further operable to prevent local authorization when a transaction processing mode of said field asset is an online mode.

29. The field asset of claim 21, wherein the EFA is further operable to prevent remote authorization when a transaction processing mode of said field asset is an offline mode.

30. The field asset of claim 21, wherein the EFA is further operable to support transaction aggregation by aggregating multiple transactions locally and remotely authorizing the resulting aggregated transaction remotely as a single transaction.

31. The field asset of claim 31, wherein the field asset comprises a vending machine.

32. A computer program product comprising instructions, stored on a computer readable medium and executable by a processor, for facilitating cashless transactions in a field asset, comprising:
instructions for locally authorizing a cashless transaction based on information stored on the field asset; and
instructions for remotely authorizing a cashless transaction based on information accessed via a remotely located transaction processing server.

33. The computer program product of claim 32, further comprising instructions for determining a transaction processing mode of the field asset and instructions for determining whether to locally authorize or remotely authorization a cashless transaction based in part on the transaction processing mode.

34. The computer program product of claim 33, further comprising instructions for locally authorizing the cashless transaction if the transaction processing mode is an offline mode and instructions for remotely authorizing the cashless transaction if the transaction processing modes is an online mode.

35. The computer program product of claim 34, further comprising instructions for remotely authorizing the cashless transaction if a remote connectivity status of the field asset is positive and locally authorizing the cashless transaction if a remote connectivity status of the field asset is negative.
